(19) United States
(12) Patent Application Publication
(10) Pub. No.: US 2017/0342966 A1
(43) Pub. Date: Nov. 30, 2017

(54) Wind Turbine With Improved Safety Features

(71) Applicant: Gerald L Barber, Greenville, SC (US)

(72) Inventor: Gerald L Barber, Greenville, SC (US)

(21) Appl. No.: 15/610,497

(22) Filed: May 31, 2017

Related U.S. Application Data
(60) Provisional application No. 62/343,495, filed on May 31, 2016.
(60) Provisional application No. 62/350,014, filed on Jun. 14, 2016.

(51) Int. Cl. F03D 80/10; F03D 9/25; F03D 13/20; F03D 1/06

(52) U.S. Cl. CPC F03D 80/10; F03D 1/0675; F03D 1/0691; F03D 9/25; F03D 1/0666; F03D 13/20; F05B 2240/912

(57) ABSTRACT

The wind turbine includes a wind driven turbine wheel rotatable about a central axis that has blades with streamers of other articles to fill the space between the blades. A set of streamers can be attached to the trailing edge of the blades at one end and including a free end wherein the free end is disposed in a space defined between adjacent blades. The streamers can also be attached to spokes.

### FIELD OF THE INVENTION

This invention concerns a wind turbine assembly for generating electricity in response to the movement of atmospheric wind and additional safety features of strike avoidance system and anchor support structure.

### BACKGROUND OF THE INVENTION

Windmills have been used for many generations for the purpose of pumping water from the ground and for generating electricity. A basic advantage of the windmill is that it uses the power of atmospheric wind to rotate a wheel having radially extending blades. This rotary movement may be converted into various useful purposes. For example, wind turbines in the form of propellers mounted on towers have been placed in areas where steady winds are prevalent and the wind turbines are used to generate electricity.

The blades of the conventional wind turbines are very large and made of expensive rigid material and are constructed to have the blades extend radially from a central hub, with no extra support at the outer tips of the blades. The conventional wind turbine blades rotate at a high rate of revolutions and must withstand both the centrifugal forces generated by the fast revolution of the blades and the cantilever bending forces applied to the blades by the wind. Since the outer portions of the blades move at a very high velocity and are engaged by strong winds, the larger the blades the stronger they must be and the more expensive they become. Thus, there is a practical limit as to the length and width of the blades.

Another type of wind turbine is one that has sail wings constructed of fabric that are a substitute for the rigid blades of the conventional wind turbines described above. For example U.S. Pat. Nos. 4,330,714, 4,350,895, and 4,729,716 disclose wind turbines that use cloth “sails” that catch the wind. The blades of the wind turbine are formed of lighter weight material. Another wind turbine type has rigid propellers that appear to be rigidly mounted to circular perimeter rims that support the outer ends of the propellers, as shown in U.S. Pat. Nos. 1,233,232 and 6,064,123.

Some of the wind turbines of the patents cited above are constructed with an outer rim that extends circumferentially about the turbine wheel. Rubber tires are placed in positions to engage the outer rim so as to rotate the rubber tires, with the driven rubber tires rotating the rotor of a generator. Thus, the rotation of the wind turbine is used to generate electricity. Other designs are shown in U.S. Pat. Nos. 8,109,727, 7,825,532, 8,134,251, 8,164,212, 8,178,993, 8,487,471, 8,174,142, 8,258,645, 8,373,298, 8,466,577, and United States Patent Application Publications 2014/0271183 and 2014/0265344, all incorporated by reference.

Prior art wind turbines are mounted on upright towers and the towers are supported at their bases by mounting the towers in the earth or on some other stable platform. When the wind turbine is in operation with an oncoming brisk wind engaging the angled blades of the turbine wheel, a significant longitudinal force is transmitted from the blades of the turbine wheel to the upper portion of the tower, tending to tip the tower. This horizontal tipping force usually is significantly greater than the circumferential wind force engaging the angled surfaces of the blades of the turbine wheel and causing the rotation of the turbine wheel. This longitudinal force requires the tower for a wind turbine to be very strong to avoid tipping over.

While wind turbines have found use in open land areas where steady winds are prevalent, the land areas most suitable for catching the wind on wind turbine propeller blades usually are remote from the areas of great need of electrical power. Therefore, there is a requirement that electrical power be transmitted through conductive cables for long distances to the areas of need.

Winds generated over large bodies of water, particularly over an ocean, are not confronted with mountains, buildings, and the vegetation of the land masses that tend to slow the velocity of winds. The turbulence of wind usually is less over water than over land. This may be because there is a greater temperature variance between different altitudes over land than over a body of water, apparently because sunlight is absorbed further into water than into land, and for comparable conditions, the surfaces of land become warmer and radiate more heat than the surfaces of water.

Also, some of the largest cities of the world are positioned adjacent large bodies of water such as oceans and seas where wind velocities are not slowed and are less turbulent near the water surface and are more predictable. Therefore, there can be some advantages to placement of a wind turbine being placed in a large body of water. This, however, does not come without challenges. One challenge is how to anchor the wind turbine so that it does not drift across the water. Several attempts have been made to provide in-water anchor systems such as U.S. Pat. No. 8,118,538 that discloses a wind turbine platform that can be semi-submersible with the wind turbine extending out of the water and with a counterbalance extending below the platform. The platform can float on the water's surface and can have several arms that extend outwardly from the wind turbine to increase the platform's footprint. To anchor the turbine offshore, anchoring systems can anchor the platform to the seabed while allowing the floating wind turbine to adjust passively or actively to changes in sea level due to tidal variations or storm swells.

United States Patent Application Publication 2013/0152839 discloses a system of floating and weight-stabilized wind turbine towers with separately floodable compartments and aerodynamic overwater encasement and the appertaining semisubmersible mooring structures including anchorage on the seabed, a horizontally floating underwater mooring meshwork and an actinomorphic buoy-cable-mooring to the wind turbine towers. United States Patent Application Publication 2010/0290839 discloses an anchoring system for anchoring an object to a floor of a body of water includes a weighted portion, an explosive charge arrangement on the weighted portion, a movable pole arranged on the weighted portion, and a penetration system that moves the pole downward after initiation of the explosive charge arrangement. United States Patent Application Publication 2009/0092449 is directed to an anchoring device for a floating wind turbine installation. Such a wind turbine installation comprises a floating cell, a tower arranged over the floating cell, a generator mounted on the tower which is rotatable in relation to wind direction and fitted with a wind rotor, and an anchor line arrangement connected to anchors or anchoring points on the seabed.

One of the disadvantages with the increased use of alternative energy systems, such as wind turbines, is the actual or perceived belief that these large spinning structures pose a hazard to birds, especially to migratory birds. In fact, in 2013, it was reported that the wind industry is killing a vast number of birds each year. Other commentators have stated that while there is a risk of bird deaths from wind turbines, the risk has been overblown. For example, a study by the United States Fish and Wildlife Service estimates that 175 million birds die annually by flying into power lines, 72 million are poisoned annually by herbicides, 6.6 million die annually by flying into communications towers and 1 million die from oil and gas waste pits. By contrast, the Wildlife Society Bulletin estimates that 573,000 birds were killed by wind turbines. Nevertheless, combatting this issue of actual or perceived unnecessary bird deaths from wind turbines is a problem that should have some attention. As wind turbines increase in popularity and use, the issue will also increase. Additionally, there has been prosecution of wind energy companies for improperly killing eagles.

There have been some attempts to prevent unnecessary bird deaths through wind turbines including that of U.S. Pat. No. 8,742,977 that discloses a bistatic radar system that detects a bird in a collision path and actuates a deterrent. Deterrents can be flashing strobe lights, intense sound, or air cannon. United States Publication 2013/0101417 discloses wind turbine rotor blades having ultraviolet light-reflective substances in order to prevent bird strikes. U.S. Pat. No. 5,774,088 discloses a hazard warning system radiates pulses of microwave energy in the frequency range of 1 GHz to about 40 GHz to alert and warn target flying birds of the presence of wind turbine electrical generators, power distribution systems, aircraft, and other protected areas from hazardous intrusion. U.S. Pat. No. 9,046,080 discloses instantaneously inflatable mini-airbags on turbine blade leading edges.

Birds are known for very good vision as it is this sense that assists with safe flight. Most birds are tetrachromatic, possessing four types of cone cells each with a distinctive maximal absorption peak. In some birds, the maximal absorption peak of the cone cell responsible for the shortest wavelength extends to the ultraviolet (UV) range, making them UV-sensitive. Birds can also resolve rapid movements better than humans with a flicker threshold of over more than 100 Hz. In humans, when an object is covered by another, the human mind tends to “complete” the covered object and “fills in the blank” to believe that the human is seeing the entire object. This is called scene completion, a trait that is not believed to be present in birds. Birds do, however, possess very good resolving power to see clear and distinct images of very small prey.

Another advantage of wind turbines placed on bodies of water is that the less turbulent winds at the surface of the water allows the turbine wheel to be supported lower, closer to the surface of the water. This tends to reduce the expense of having a tall tower as usually required for land mounted wind turbines.

Accordingly, it would be desirable to locate wind turbines on bodies of water spaced relatively close to a land mass where there is a need for electricity. Also, it would be desirable to produce wind turbines with a means for reducing the longitudinal force applied by the turbine wheel to the tower or other vertical support of the wind turbine.

If would also be advantageous to take advantage of the good vision of birds and construct and arrange a wind turbine with additional visual safety features to allow birds to detect the wind turbine and avoid a collision at the onset.

### SUMMARY OF THE DISCLOSURE

Briefly described, this disclosure concerns a wind turbine assembly for generating electricity that includes a support, a turbine wheel rotatably mounted on the support about a longitudinally extending central axis, the turbine wheel including a circular rim concentric with and rotatable about the central axis, and an electrical generator in a driven relationship with the turbine wheel.

The invention can include a hub rotatably attached to a foldable tower assembly; a set of wind turbine blades attached to the hub and radiating away from the hub; an outer perimeter circular rim attached to the set of wind turbine blades at a wind turbine blade distal end of each wind turbine blade; a generator operatively associated with the outer perimeter circular rim so that the generator is rotated when the outer perimeter circular rim rotates; a set of streamers carried by a trailing edge of each wind turbine blade wherein the length of each individual streamers increases as an attachment point associated with each streamer is disposed closer to the distal end the wind turbine blade and the streamer is disposed in a space defined between wind turbine blades when the hub is rotating; a color associated with each streamer determined by the luminance of the streamer and the luminance of the surrounding environment having a luminance contrast; a set of spokes extending between the hub and the outer perimeter circular rim so that the spokes rotate when the hub rotates where in streamers are attached to the spokes; and, wherein the streamers are configured to generate noise to deter birds and bats from entering the space between turning blades.

The streamers can include reflective properties to reflect multiple colors of visible, ultraviolet and infrared light. The color of the streamers can be taken from the group consisting of wavelengths in the range of 300 nm and 650 nm, in the range of 560 nm to 570 nm, in the range of 500 nm to 510 nm, in the range of 430 nm to 460 nm, in the range of 400 nm to 420 nm, in the range of 360 nm to 380 nm, or any combination thereof. The noise generated has a frequency selected from the group comprising the range of 1 kHz to 200 kHz, the range of 20 Hz to 20 kHz, the range of 1 kHz and 4 kHz, or any combination thereof. The lower range of the noise can be 10 kHz. The luminance contrast can be greater than 125 using the RGB scale. The set of streamers can include a set of perimeter streamers, a set of intermediate streamers and a set of inner streamers wherein the perimeter streamers are longer than the intermediate streamers and the intermediate streamers are longer than the inner streamers. The streamers can have a width to length ratio equal to or greater than 1:85.

### BRIEF DESCRIPTION OF THE DRAWINGS

The features and advantages of the structure and process disclosed herein may be understood from the following specification and accompanying drawings.

FIG. 1 is a front elevation view of aspects of the invention;

FIG. 2 is a side elevation view of aspects of the invention;

FIG. 3 is a front view of aspects of the invention;

FIG. 4 is a side view of aspects of the invention;

FIG. 5 is a top view of aspects of the invention;

FIG. 6 is an edge view of aspects of the invention;

FIG. 7 is an edge view of aspects of the invention;

FIG. 8 is a front view aspects of the invention; and,

FIGS. 9 to 11 are a front views aspects of the invention.

### DETAILED DESCRIPTION

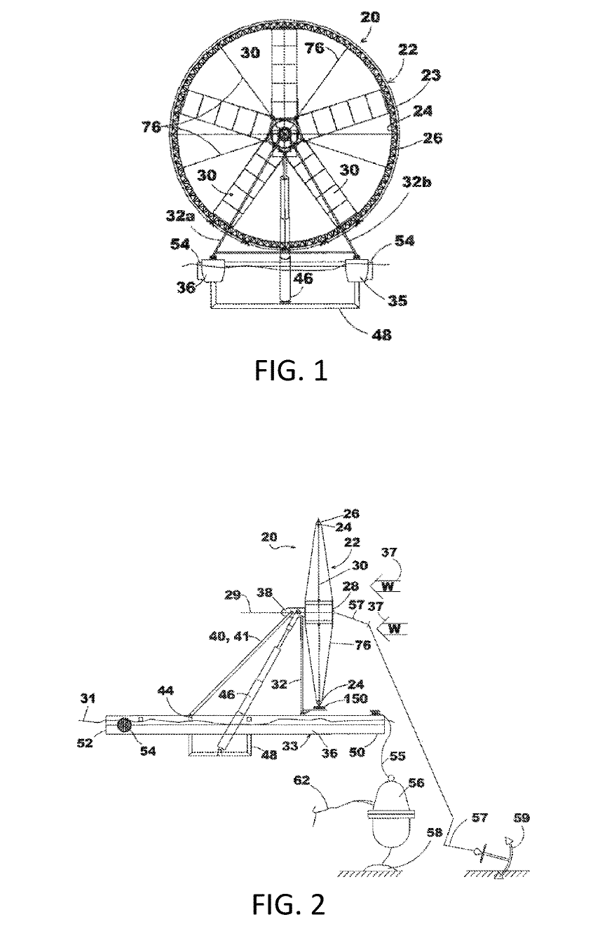

Referring now in more detail to the drawings in which like numerals indicate like parts throughout the several views, FIGS. 1 and 2 show a wind turbine 20 that is designed for catching the wind and rotating for the purpose of generating electricity. The wind turbine includes a turbine wheel 22 having an outer perimeter 23 formed by a series of angle braces 24 and an outer perimeter circular rim 26 that extends continuously about the turbine wheel. The outer perimeter circular rim may be formed of arcuate segments, and as explained in more detail hereinafter, the perimeter rim may function as the rotor of an electrical generator, or may function to drive a rotor of an electrical generator.

An axle structure 28 is at the center of the turbine wheel 22 and a plurality blades or sail wing assemblies 30 are mounted to the axle structure 28 and extend radially toward the angle braces 24 that form the perimeter of the turbine wheel. The turbine wheel rotates about the central axis 29.

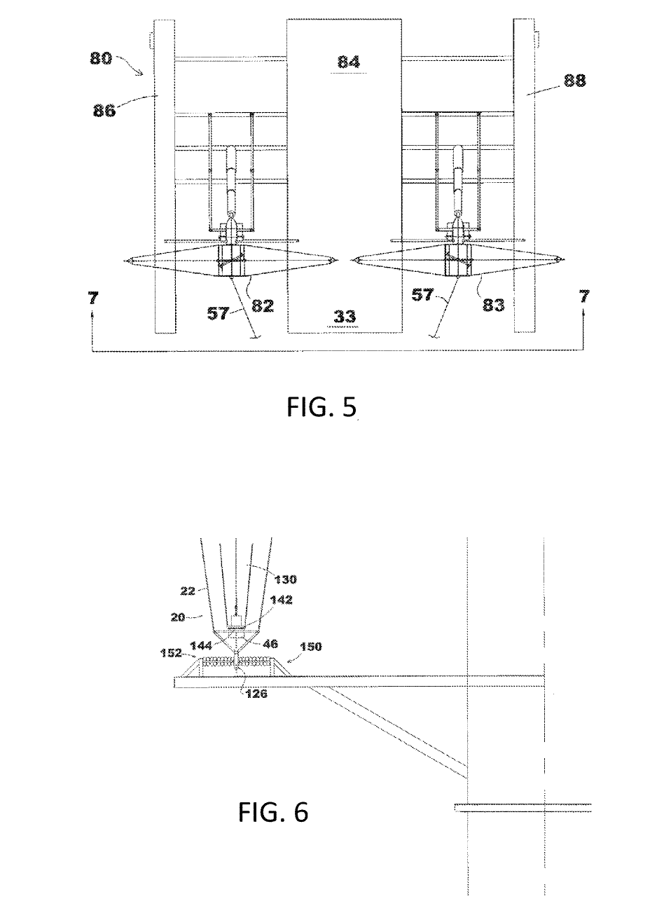

The wind turbine assembly may be used on a body of water such as an ocean or lake 31 where the atmospheric wind 37 usually is of higher velocity, less turbulent and more predictable than the atmospheric wind over a land mass. When used on water, the turbine assembly may include a floatable support 33, such as a pontoon boat structure, barge or other suitable floatable support. The floatable support can be a pontoon boat structure having parallel pontoons 35 and 36. The wind turbine assemblies include a foldable tower assembly 32 that includes a pair of tower arms 32A and 32B that are connected at their lower end portions to pontoons 36 and 35, respectively, and converging upwardly toward one another in a vertical plane to an upward apex that is in support of the bearing housing 38 at the axial structure 28 of the turbine wheel 22. The tower arms 32A and 32B are foldable about their lower ends to an attitude more horizontal, as shown in FIG. 5, so that the turbine wheel 22 moves more toward a supine position over the pontoons 35 and 36.

Stabilizing arms 40 and 41 are parallel to one another and sloped upwardly from the pontoon boat and are pivotally mounted to the bearing housing 38. The lower ends of the stabilizing arms 40 and 41 are releaseably connected to the cross frames of the pontoon boat, such as cross frame 44. When the turbine wheel 22 is to be tilted toward its supine position, the lower ends of the stabilizing arms 40 and 41 are detached from the cross frame member 44, allowing the turbine wheel 22 to tilt toward its supine position.

Hydraulic cylinder 46 is mounted at its lower end to depending framework 48 and at its upper end to the bearing housing 38. When the hydraulic cylinder 46 is distended, it holds the foldable tower assembly 32 in its upright attitude, allowing the stabilizing arms 40 and 41 to be connected at their lower ends to the cross frame member 44, thereby holding the turbine wheel 22 in its upright position. However, when the stabilizing arms 40 and 41 are disconnected at their lower ends from the cross frame member 44, the hydraulic cylinder 46 may be retracted, causing the turbine wheel 22 to tilt toward its supine position. The foldable support may be used when transporting the wind turbine assembly to and from its site of operation, and for maintenance or repair. The wind turbine also may be supported on a non-foldable, more permanent upright tower carried by the floatable support, if desired.

The floatable support 33 of the wind turbine assembly 20 is considered to have a bow at 50 and a stern at 52. The turbine wheel 22 faces the bow 50. Lateral thrusters 54 may be mounted to the pontoons 35 and 36, typically at the stern 52 of the pontoons. The bow 50 may be connected by a first anchor line 55 or other appropriate means to an anchor such as to an anchored buoy 56 that functions as an anchor. The anchor 56 may comprise a pier, anchor, dock, or other means that generally is not movable from a designated position in or adjacent a body of water. The anchor line 55 may be a chain, cable, twisted hemp rope or other conventional means or combination of these and other connectors for connecting the floatable support to an anchor.

When the atmospheric wind 37 moves against the wind turbine assembly 20, the anchor (buoy, pier, etc.) to which the wind turbine assembly is tied stabilizes the bow 50 of the floatable support, usually causing the wind turbine assembly to move downwind of its anchor. In order to assure that the turbine wheel 22 faces the oncoming atmospheric wind, the lateral thrusters 54 shown may be actuated in response to a wind direction finder (not shown), tending to turn the floatable support and, therefore, the turbine wheel more directly into the atmospheric wind.

The lateral thruster can be mounted to the stern of the floatable support so that the anchor stabilizes the bow of the floatable support while the lateral thrusters tend to swing the stern in alignment with the bow and atmospheric wind. This assist with the turbine wheel more directly facing the oncoming atmospheric wind, taking advantage of the wind movement through the blade or sail wing assemblies, causing efficient rotation of the turbine wheel.

The anchor, such as a buoy 56, pier or other stationary docking point 58 for the wind turbine assembly includes an electrical connection (not shown) to the electrical generator 150 of the wind turbine assembly 20 and an electrical conductor 62 to a receiver that may be on an adjacent land mass for transmitting the electrical power generated by the wind turbine assembly.

The turbine wheel and its floatable support may be very large in length, width and height. Because of the uncontrolled velocity of the atmospheric wind and because of the large height and other large size dimensions of the wind turbine assembly, it is desirable to construct the wind turbine assembly so that it resists capsizing or tilting or other deviation from facing the atmospheric wind and is desirable to minimize the application of longitudinal and other horizontal forces to the tower 32 and its stabilizing arms 40 and 41. In addition or alternatively, a second anchor line 57 may be connected at one of its ends to the axle structure 28 of the turbine wheel 22 and connected at its other end to an anchor 59. The second anchor line 57 may be made of materials the same as or similar to those described above for the first anchor line. The second anchor may be any device that resists movement, including stationary structures such as piers, buoys, conventional anchors and other devices suitable for holding the wind turbine assembly in its predetermined position, including but not limited to those described above for the first anchor. Typically, if the anchor line is to be connected to a submerged anchor, the anchor line should be long enough to have a length to height ratio of at least about seven to one.

The connection of the second anchor line 57 to the axle structure 28 of the turbine wheel 22 is at the center of the wind forces applied to the turbine wheel. The centered connection of the anchor line to the turbine wheel provides a balanced longitudinal support for the wind turbine, directly opposite to the direction of the on-coming wind 37, and relieves force otherwise applied by the turbine wheel to the tower structure that extends from the turbine wheel to the floatable support. Since the turbine wheel usually is centered over an intermediate portion of the floatable support, the restraining forces applied by the anchor line to down-wind movement of the wind turbine assembly tend to maintain the wind turbine assembly in its upright attitude and facing the oncoming atmospheric wind. The connection of the anchor line 57 to the axle structure is at the upper end portion of the tower assembly 32 opposes and resists the longitudinal forces applied by the oncoming wind forces that are being applied to the wind turbine wheel 22. Thus, the force applied by the anchor line resists the tipping of the tower 32 and allows the tower structure to be less strong, less expensive and lighter than would be required without the anchor 59 and anchor line 57.

The axle structure of the turbine wheel can have a greater thickness than the circular perimeter rim. A plurality of spokes can extend from the ends of the axle structure outwardly and converge into a supporting relationship with respect to the circular perimeter rim. This provides lateral and radial stability to the circular perimeter rim.

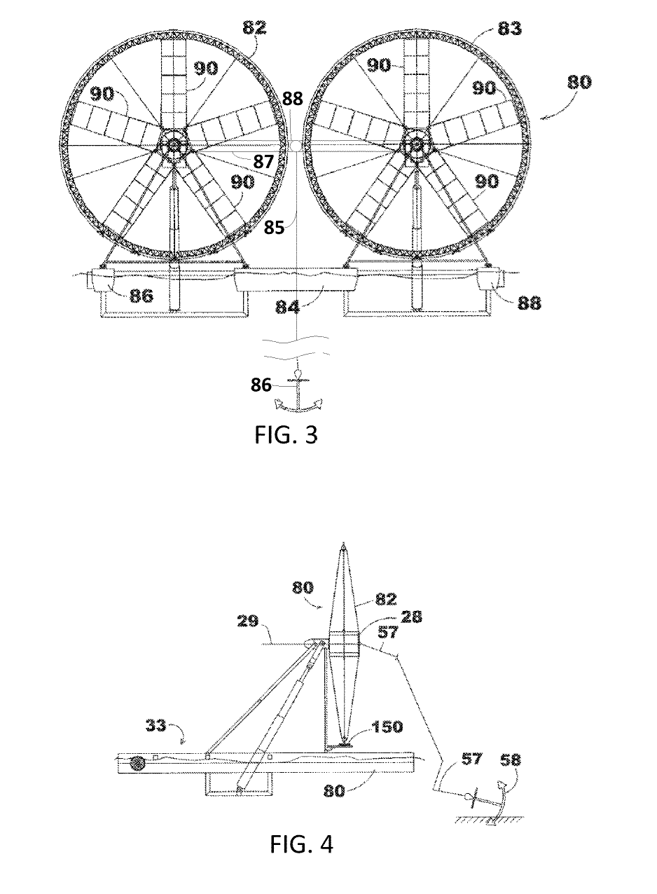

FIGS. 3 through 5 show a wind turbine assembly 80 that is a “twin” assembly of the wind turbine assembly, that includes turbine wheels 82 and 83. The floatable support 33 can be modified to provide a central pontoon 84, with parallel outer pontoons 86 and 88, all pontoons supporting the turbine wheels. The blades, without perimeter, or sail wings 90 of one turbine wheel 82 may be oriented with a pitch so that the atmospheric wind will rotate the turbine wheel in a clockwise direction, whereas the sail wings 90 of the other turbine wheel 83 are oriented at a reverse pitch from that of the turbine wheel 82. This causes the turbine wheels to rotate in opposite directions when facing the oncoming atmospheric wind. This tends to neutralize the gyroscopic effect of the rotation of the turbine wheels of the twin wind turbine assembly 80.

An anchor line 85 can be connected at its distal end to the anchor 86 and connected at its proximal end to a horizontal cross brace 87 that functions as a horizontal tower. The horizontal cross brace 87 is connected at its end portions to the housing of the axle structure 28 of each turbine wheel. A rigid connector 88 can be connected at one of its ends to the horizontal brace 87 and extents forwardly between the turbine wheels 82, 83 and connects to the more flexible anchor line 85. This avoids contact between the more flexible anchor line 85 and the turbine wheels 82 and 83. This places the longitudinal support applied by the anchor 86 and anchor line 85 at the axial center of the turbine wheels, at the desired mid-height of the turbine wheels, above the base of the tower, where the force applied by the anchor is centered at the axle structure of each turbine.

Referring to FIG. 6, at least one electrical generator 170 is positioned at the lower arc of the circular perimeter rim of the turbine wheel. The rotary movement of the circular perimeter rim is used to develop electrical power. The outer perimeter circular rim 126 of the turbine wheel 22 functions as the rotor of the generator. The outer rim can contact a resilient member 127 that can be attached to the shaft of a generator. In one embodiment, the resilient member is a circular member similar in design to a tire or other rotational resilient member. The turbine wheel may be of very large diameter, in excess of 100 feet in diameter.

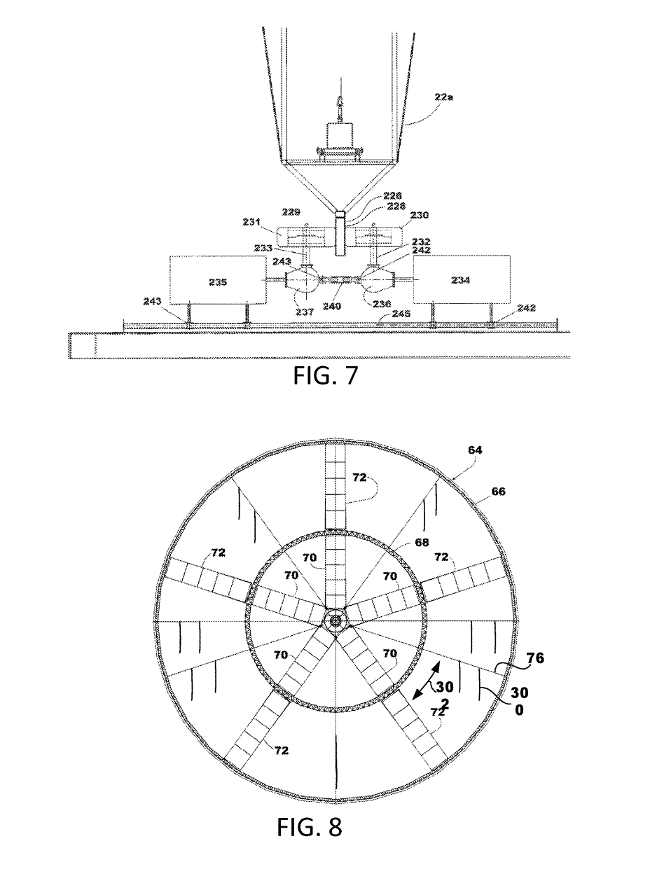

Referring to FIG. 7, the perimeter rim 226 of the turbine wheel includes opposed, laterally outwardly facing surfaces 228 and 229 that move in unison with the turbine wheel 22A. A pair of rotary members, such as rubber tires 230 and 231 are supported in engagement with the outwardly facing surfaces 228 and 229, respectively, of the perimeter rim 226. The tires are supported on axles 232 and 233, and the axles are connected to the electrical generators 234 and 235, respectively, through gear boxes 236 and 237. Turnbuckle 240 is connected at its opposite ends by bearings 242 and 243 to the axles 232 and 233, respectively. The turnbuckle is tightened so that the tires 230 and 231 make firm and resilient engagement with opposed surfaces of the perimeter rim 226 of the turbine wheel. The electrical generators 234 and 235 can be are mounted on wheels 242 and 243, respectively, and the wheels engage rails 245.

It is anticipated that the diameter of the turbine wheel 20A shall be large, in some instances more than 100 feet in diameter. Because of the great size of the turbine wheel and because of slight lateral movement of the turbine wheel induced by intensity and direction of the atmospheric winds, the perimeter rim 226 is likely to move laterally, as well as in its circular path. The arrangement of the support system for the rotary members 230 and 231 is formed so as to compensate for the lateral movement. For example, if the perimeter rim 226 at its lower arc of FIG. 18 moves to the left of FIG. 18, the rotary members 230 and 231, as well as their attached components, including the gear boxes 236 and 237, turnbuckle 240, and electrical generators 234 and 235 are free to move to the left, by the rollers 242 and 243 moving along the rails 245. Likewise, movement to the right is accommodated in the same way.

Referring to FIG. 8 showing the turbine wheel stationary, there can be a forward set of spokes and a rearward set of spokes in one embodiment. The forward set of spokes are disposed closest to the anchor line with the rear ward set of spokes disposed at the rear of the platform. The forward set of spokes can include streamers 300 that are attached to a point between the terminal end of the spokes. In one embodiment, the streamers can extend more than half way along a radial distance 302. An outer set of streamers is attached to the spokes between the intermediate rim and the outer rim. An inner set of streamers can be attached to the spokes inside the perimeter of the intermediate rim. The spokes can be arranged to be offset from the inner and outer sail wing so that when viewing the turbine wheel from the front, the spokes are interlaced with the outer and inner sail wings. The streamers can be a natural or synthetic material and can be UV reflective allowing the bird to see the streamer and avoid it in flight. The outer rim can also be UV reflective.

The streamers (or tell tales) can have various colors along the visual spectrum as well as the UV and IR spectrum that can be detected by different species of birds and bats. In one embodiment, the streamers are reflective with the ability to reflect visible, infrared and ultraviolet wavelengths allowing birds and bats to perceive that the space between the blades is not available for travel. The streamers can be designed of an adequate material, length, thickness and width that are configured to impart motion and fill, partially fill and configured to create a perception that the empty space between blades are not travel paths for birds and bats. In one embodiment, the streamers themselves can be shaped on the trailing edge or lateral sides and configured to generate noise that are in the frequency range to deter birds and bats from entering the empty space between the blades. In one embodiment the frequency range that is generated by the streamers is 1 kHz to 200 kHz. In one embodiment the lower range is 10 kHz. In one embodiment, the range of frequencies is 20 Hz to 20 kHz which is particularly beneficial for deterring birds. In one embodiment the range of 1 kHz and 4 kHz.

In one embodiment, the streamers can reflect colors or be colored in the wavelength of between 300 nm and 650 nm. In one embodiment, the streamers can provide of reflect light in the range of 300 nm to 400 nm (ultraviolet). The streamers can be configured to reflect or provide color that matches one or more of a birds visual receptors and taken from the ranges comprising: 560 nm to 570 nm (LWS (red cones)), 500 nm to 510 nm (MWS (green cones) and rods), 430 nm to 460 nm (SWS (blue cones)), 400 nm to 420 nm (UVS (violet)) and 360 nm to 380 nm (UVS (ultra-violet)).

In one embodiment, the length of the streamers decreases as the streamers that are disposed along the spokes are positioned closer to the center of the turbine wheel. This allows for a consistent visual effect to allow the turbine wheel to appear to have more structure so that birds can avoid striking the turbine wheel. The streamers can be disposed in a space defined between adjacent spokes, in spaces defined between the spoke and the sail wings, and in spaces between the outer rim and the intermediate rim when the turbine wheel is rotating. The streamers can be of a length that is less than the distance between adjacent spokes, about half the distance between adjacent spokes, greater than about half the distance between adjacent spokes or any combination. The streamers can have different colors and the color of the streamers can be selected according to the surrounding environment to allow birds to use their ability to see colors and contrast. For example, a color for the streamers can be selected with a different color and brightness than the surrounding environment.

In one embodiment, the color is selected using the formula:

$$\frac{I - {I}_{b}}{{I}_{b}}$$

where I is the luminance of the streamers and I_{b} is the luminance of the surrounding environment. In one embodiment, the luminance contrast should be greater than 125 using the RGB scale. Based upon the relationship of the turbine wheel to the landscape, the color of the streamers can be different at the perimeter of the turbine wheel than the center based upon the environmental background that is present in contrast to the turbine wheel.

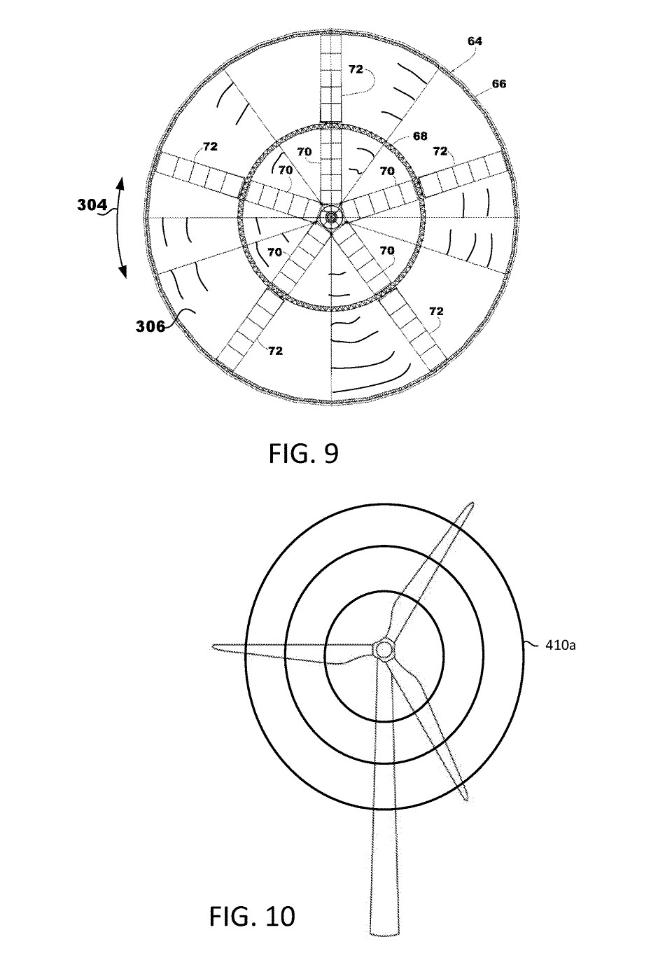

Referring to FIG. 9, the turbine wheel is shown rotating in direction 304. The streamers, due to a variety of acting forces, including forward motion, resistance and centripetal force, extend rearward from the leading spoke and are disposed in a space defined between adjacent spokes such as 306. The streamers can be disposed in a space defined between a spoke and an outer and inner sail wing. When the turbine wheel rotates, the streamers allow the turbine wheel to be more easily visible and therefore allow birds to better see the wheel turbine and avoid flying into it. The streamers can be varying lengths that can be longer at the perimeter of the turbine wheel and shorter near the center of the turbine wheel.

Referring to FIG. 10, a mast 400 supports a blade assembly 402 that can include a hub 404 and blades 406a through 406c. Each blade can include one or more visual indicators 408a through 408c. The visual indicators can be flexible material such as a streamer or telltales attached at or near the trailing edge of the blade. When the blade is rotating , the streamers extend away from the trailing edge and travel in a circular path dictated by the rotation of the blade. The streamers, or at least the potion near the attachment point of the streamer to the blade, can generally be perpendicular to the trailing edge.

In one embodiment, a perimeter streamer 408a can be the longest of a set of streamers as its rotational path 410 (FIGS. 23B) is the longest in the set. The intermediate streamer 408b can be shorter than the perimeter streamer. The inner streamer 480c can be shorter than the intermediate streamer. The various lengths of the streamer allows them to extend into the space 412 between the blades. The streamers a positioned in the travel path of the fan blades between the blades. This allows a sufficient visual effect to allow birds to see the space and avoid entering the space. In one embodiment. The perimeter streamer is between 50% and 99% the length of the blade from tip to the hub connection. The intermediate streamer is between 20% and 50% the length of the blade from tip to the hub connection. The inner streamer is between 1% and 33% the length of the blade from tip to the hub connection.

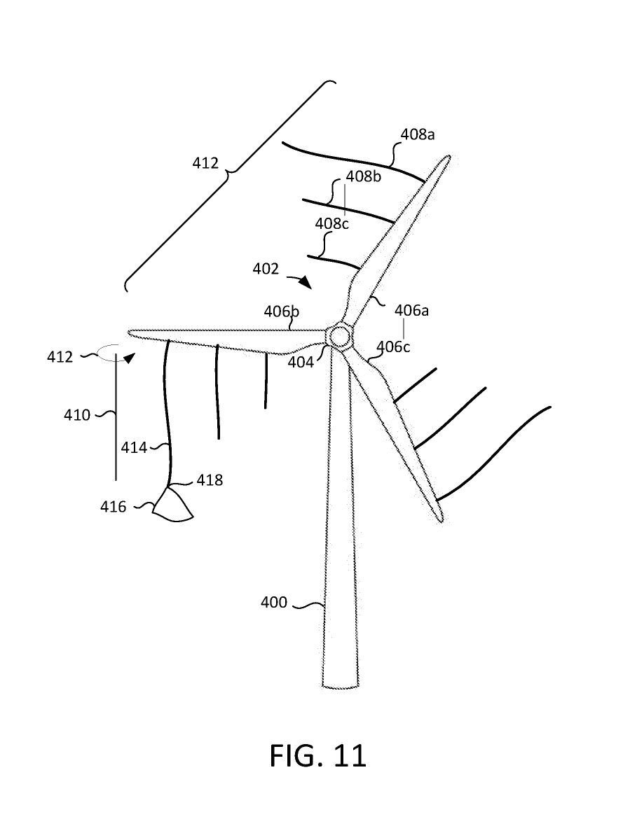

Referring to FIG. 11, the travel paths are shown. One method is to have multiple streamers that are between 5 inches and 36 feet attached along multiple points of the trailing edge creating multiple travel paths. The visual effect created, including a positive afterimage, allows the space between the blade to appear sufficiently solid to the birds so that the birds do attempt to travel between the blades. The streamers can be a rigid material, semi-rigid or flexible (e.g. mylar). The streamers can include a graphic imprinted on one or more streamers for such purposes as warnings or advertising. In one embodiment, when the streamers are rotating the imprinted images on one or more streamers create the illusion of static or dynamic image. For example, when the streamers are rotating, the imprinted streamers can provide the illusion of a rotating spiral.

The streamers can rotate about an axis 410 that is generally orthogonal to the trailing edge of the blade with such rotation being shown generally at 412. The streamers can include a fairly thin or narrow body 414 with an object 416 or image at the distal end to the blade or attachment point. The object can rotate by swivel 418. In one embodiment, the streamer can rotate itself in a direction 412 (or opposite direction) and can include a swivel attachment between the blade and the streamer. The streamer can include an air foil shape to allow the streamer to move along it travel path. For example, a airfoil shape at the free end of the streamer can cause the streamer to move laterally while it is rotating. The streamer or attached object can include lights. The lights can be powered by induction charged power source of induction power source to take advantage of the motion of the streamers or blades.

In one embodiment, the streamers can include electrical properties such as being configured to act as lightening arresters, static electricity dissipaters and broadcast antennae. The streamers can also be made of a radar opaque material to increase the radar signature of the area occupied by the blades.

In a wind turbine, the blades can be quite long including lengths of 100 feet and longer. With these long blades, the space between the blades can include several sectors. The sector innermost to the area encompassed by the turning blades may not been the same number of streamers as the blades themselves can be seen by birds and prevent bird from entering an inner sector. The inner section can be defined as the area occupied by the inner most 1/4 of the turning blades. In one embodiment, the inner area can be defined as the inner most ⅓ of the turning blades. A streamer can be placed at the perimeter of the inner segment to define the perimeter of the inner most segment. In one embodiment, the area of the inner segment can be in the range of about 395 ft² to 1500 ft². The travel path of a streamer placed at the perimeter of the inner most segment can be in the range of 70 ft to 140 ft.

Moving from the inner segment of the travel path of the tip of the blade, the area covered by the blade increase thereby increasing the space between portions of the blade. As such, the number of streamer can increase moving toward the tip of the blade, the length of the streamers can increase moving to the tip of the blade of both. As the attachment points of the streamers move toward the tip of the blade, the travel path increases. The area covered by the streamers can be divided into segments as shown below:

| Blade | | Inner | Inner | | Outer | Outer |
|---|---|---|---|---|---|---|
| Length | Perimeter | Qtr | Third | Middle | Third | Qtr |
| | Area Covered by Blade/Streamers | | | | | |
| 90 | 6361.73 | 397.61 | 692.79 | 1590.43 | 2771.17 | 3578.47 |
| 116 | 10568.32 | 660.52 | 1150.89 | 2642.08 | 4603.56 | 5944.68 |
| 148 | 17203.36 | 1075.21 | 1873.45 | 4300.84 | 7493.78 | 9676.89 |
| 143 | 16060.61 | 1003.79 | 1749.00 | 4015.15 | 6996.00 | 9034.09 |
| 175 | 24052.82 | 1503.30 | 2619.35 | 6013.20 | 10477.41 | 13529.71 |
| | Travel Path (Perimeter) | | | | | |
| 90 | 282.74 | 70.69 | 93.31 | 141.37 | 186.61 | 212.06 |
| 116 | 364.42 | 91.11 | 120.26 | 182.21 | 240.52 | 273.32 |
| 148 | 464.96 | 116.24 | 153.44 | 232.48 | 306.87 | 348.72 |
| 143 | 449.25 | 112.31 | 148.25 | 224.62 | 296.50 | 336.94 |
| 175 | 549.78 | 137.44 | 181.43 | 274.89 | 362.85 | 412.33 |

In one embodiment the range of lengths of the streamers for the areas between the tip and the inner segment can range from 20 ft to 100 ft. for blade that are 90 feet in length or longer. The streamers can be made from polymers such as mylar. The trailing edge of the streamers can be reinforced with a glue, seam, edging, or other material to reduce or prevent fraying.

While the expression “electrical generator” has been used herein, it should be understood that this term may identify other rotary devices that may be driven by the wind turbines disclosed herein, such as alternators, pumps, etc.

It will be understood by those skilled in the art that while the foregoing description sets forth in detail preferred embodiments of the present invention, modifications, additions, and changes might be made thereto without departing from the spirit and scope of the invention, as set forth in the following claims.

What is claimed is:

1. An improved safety feature for wind turbines comprising:
a hub rotatably attached to a foldable tower assembly;
a set of wind turbine blades attached to the hub and radiating away from the hub;
an outer perimeter circular rim attached to the set of wind turbine blades at a wind turbine blade distal end of each wind turbine blade;
a generator operatively associated with the outer perimeter circular rim so that the generator is rotated when the outer perimeter circular rim rotates;
a set of streamers carried by a trailing edge of each wind turbine blade wherein the length of each individual streamers increases as an attachment point associated with each streamer is disposed closer to the distal end the wind turbine blade and the streamer is disposed in a space defined between wind turbine blades when the hub is rotating;
a color associated with each streamer determined by the luminance of the streamer and the luminance of the surrounding environment having a luminance contrast;
a set of spokes extending between the hub and the outer perimeter circular rim so that the spokes rotate when the hub rotates where in streamers are attached to the spokes; and,
wherein the streamers are configured to generate noise to deter birds and bats from entering the space between turning blades.

2. The safety feature of claim 1 wherein the streamers include reflective properties to reflect multiple colors of visible, ultraviolet and infrared light.

3. The safety feature of claim 2 wherein the color of the streamers is taken from the group consisting of wavelengths in the range of 300 nm and 650 nm, in the range of 560 nm to 570 nm, in the range of 500 nm to 510 nm, in the range of 430 nm to 460 nm, in the range of 400 nm to 420 nm, in the range of 360 nm to 380 nm, or any combination thereof.

4. The safety feature of claim 1 wherein the noise generated has a frequency selected from the group comprising the range of 1 kHz to 200 kHz, the range of 20 Hz to 20 kHz, the range of 1 kHz and 4 kHz, or any combination thereof.

5. The safety feature of claim 4 wherein the lower range is 10 kHz.

6. The safety feature of claim 1 wherein the luminance contrast is greater than 125 using the RGB scale.

7. The safety feature of claim 1 wherein the set of streamers include a set of perimeter streamers, a set of intermediate streamers and a set of inner streamers wherein the perimeter streamers are longer than the intermediate streamers and the intermediate streamers are longer than the inner streamers.

8. The safety feature of claim 7 wherein the perimeter streamers are in the range of 50% to 99% the length of the attached wind turbine blade.

9. The safety feature of claim 1 wherein each streamer have a width to length ratio equal to or greater than 1:85.

10. The safety feature of claim 1 wherein the streamer is radar opaque.

11. The safety feature of claim 1 wherein the streamer includes electrical properties taken from the group consisting of lighting arrester, static electricity dissipater, electrical broadcaster, or any combination thereof.

12. The safety feature of claim 1 including a light attached to at least one streamer.

13. The safety feature of claim 1 including a graphic so that when the hub is rotating, the streamers produce a visually perceivable image wherein the image is not visually perceivable when the hub is stationary.

14. An improved safety feature for wind turbines comprising:
a hub;
a set of wind turbine blades attached to the hub and radiating away from the hub; and.
a set of streamers carried by a trailing edge of each wind turbine blade wherein the length of each individual streamers increases as an attachment point associated with each streamer is disposed closer to a distal end the wind turbine blade.

15. The safety feature of claim 14 wherein the streamers are include reflective properties to reflect multiple colors of visible light, ultraviolet and infrared light.

16. The safety feature of claim 15 wherein the color of the streamers are taken from the group consisting of wavelengths in the range of 300 nm and 650 nm, in the range of 560 nm to 570 nm, in the range of 500 nm to 510 nm, in the range of 430 nm to 460 nm, in the range of 400 nm to 420 nm, in the range of 360 nm to 380 nm, or any combination thereof.

17. The safety feature of claim 14 wherein the streamers are configured to generate noise.

18. The safety feature of claim 17 wherein the noise generated has a frequency selected from the group comprising the range of 1 kHz to 200 kHz, the range of 20 Hz to 20 kHz, the range of 1 kHz and 4 kHz, or any combination thereof.

19. An improved safety feature for wind turbines comprising:
a wind turbine having a rotatable hub;
a set of wind turbine blades attached to the hub and radiating away from the hub;
a set of streamers carried by the wind turbine; and,
wherein the streamers include reflective properties to reflect multiple colors of visible light, ultraviolet and infrared light and the streamers are configured to generate noise to deter birds and bats from entering the space between turning blades.

20. The safety feature of claim 19 wherein the streamers include a graphic so that when the hub is rotating, the streamers produce a visually perceivable image wherein the image is not visually perceivable when the hub is stationary.
